(19) United States
(12) Patent Application Publication
(10) Pub. No.: US 2024/0364240 A1
(43) Pub. Date: Oct. 31, 2024

(54) ELECTRICITY GENERATION METHOD AND APPARATUS

(71) Applicant: Trevor Brown, Lake Geneva, WI (US)

(72) Inventor: Trevor Brown, Lake Geneva, WI (US)

(21) Appl. No.: 18/643,481

(22) Filed: Apr. 23, 2024

Related U.S. Application Data
(60) Provisional application No. 63/461,772, filed on Apr. 25, 2023.

(51) Int. Cl. H02N 11/00

(52) U.S. Cl. CPC H02N 11/008

(57) ABSTRACT

An artificial electro-magnetic field is established and an electrical conductor is provided. Electricity from the electrical conductor is generated by relative movement between the artificial electro-magnetic field and the electrical conductor, which relative movement occurs via movement of at least one celestial body, to produce harvested electricity.

### CROSS-REFERENCE TO RELATED APPLICATIONS

This application claims the benefit of U.S. Provisional Application No. 63/461,772 filed Apr. 25, 2023 which is incorporated herein by reference in its entirety.

### TECHNICAL FIELD

These teachings relate generally to the generation of electricity and more particularly to the generation of electricity via interaction between an electrical conductor and an artificial electro-magnetic field.

### BACKGROUND

Electricity is a form of energy resulting from the presence and flow of electric charge. The flow of electric charge refers to the movement of electrons or ions within a conductor.

Electricity can be generated in an electrical conductor through a process known as electromagnetic induction, which is governed by Faraday's Law of Induction. When there is relative movement between an electrical conductor and a magnetic field, the magnetic flux through the conductor varies. This change in magnetic flux in turn induces an electromotive force across the conductor, thereby generating a resultant electric current.

The applicant has determined that there exists a need for more efficient ways to generate electricity, and especially large amounts of electricity, via electromagnetic induction.

### BRIEF DESCRIPTION OF DRAWINGS

The above needs are at least partially met through provision of the electricity generation method and apparatus described in the following detailed description, particularly when studied in conjunction with the drawings, wherein:

FIG. 1 comprises a flow diagram as configured in accordance with various embodiments of these teachings;

FIG. 2 comprises a schematic diagram as configured in accordance with various embodiments of these teachings;

FIG. 3 comprises a block as configured in accordance with various embodiments of these teachings;

FIG. 4 comprises a flow diagram as configured in accordance with various embodiments of these teachings;

FIG. 5 comprises a flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated.

### DETAILED DESCRIPTION

Generally speaking, many of these embodiments provide for establishing an artificial electro-magnetic field and for providing an electrical conductor, and then harvesting electricity from the electrical conductor that is generated by relative movement between the artificial electro-magnetic field and the electrical conductor, which relative movement occurs via movement of at least one celestial body, to produce the harvested electricity.

The foregoing at least one celestial body may comprise at least one of a natural space-borne body (such as a planet such as the Earth) or an artificial space-borne body (such as a satellite). By one approach, these teachings will accommodate using an artificial space-borne body that orbits a natural space-borne body (where, for example, the aforementioned electrical conductor is disposed on the natural space-borne body and the artificial electro-magnetic field is generated from the artificial space-borne body).

By one approach, these teachings will accommodate establishing the artificial electro-magnetic field from, and providing the electrical conductor on, a shared celestial body.

In a typical application setting, the aforementioned relative movement can comprise a relatively high speed, such as the speed of a satellite orbiting the Earth (at a speed, for example, of at least 28,000 kilometers per hour) or the speed of the Earth orbiting the sun (at a speed of at least 100,000 kilometers per hour).

By one approach, these teachings will accommodate a space-based component that is disposed in motion with respect to a celestial body (for example, by orbiting that celestial body), the space-based component comprising, at least in part, an artificial electro-magnetic field generator that generates an artificial electro-magnetic field, as well as at least one electrical conductor that is disposed on the celestial body, the at least one electrical conductor comprising a harvested electricity output configured to output electricity that is generated by relative movement between the artificial electro-magnetic field and the at least one electrical conductor, which relative movement occurs via movement of the at least one celestial body. That at least one electrical conductor may, for example, comprise at least one thousand tons of electrically-conductive material that may be shaped in the form of a coil.

These teachings are capable of producing considerable amounts of harvested electricity, sufficient to power, for example, such applications as creating antimatter anti-particles, producing hydrogen, powering at least one data processor and at least one data storage system, or simply providing electric power to at least one power distribution grid, to note but a few examples.

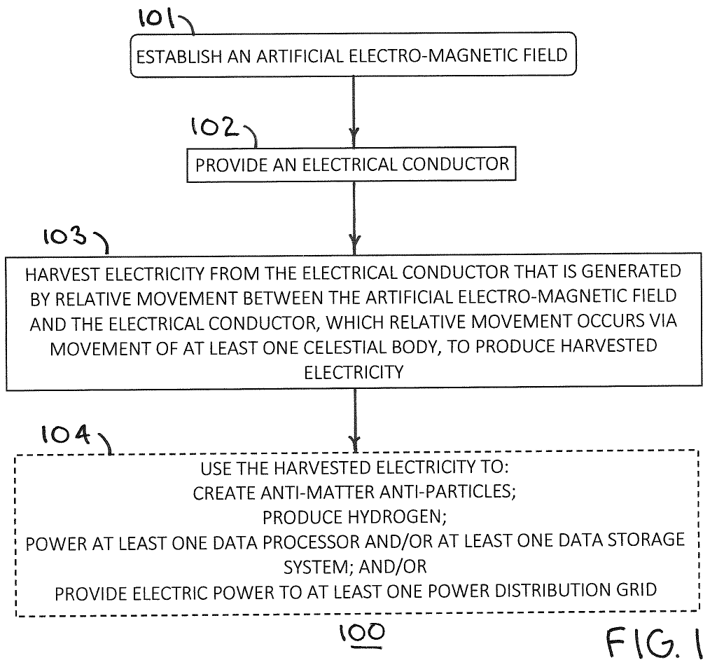

These and other benefits may become clearer upon making a thorough review and study of the following detailed description. Referring now to the drawings, and in particular to FIG. 1, an illustrative process 100 that is compatible with many of these teachings will first be presented.

At block 101 this process 100 provides for establishing an artificial electro-magnetic field. By one approach, this artificial electro-magnetic field is established on a celestial body such as a natural space-borne body or an artificial space-borne body. These teachings will accommodate various ways to establish such a field. It should also be understood that these teachings will accommodate using both naturally-occurring magnetic fields as well as artificially-occurring magnetic fields. The artificial electro-magnetic field may be a constant field, or may be periodic in nature if desired. The teachings will also accommodate selectively varying the strength of the field (for example, as a function of time or of some other operating parameter(s)).

Electric currents produce magnetic fields. Such electric currents can be macroscopic, for example in a wire, or, as another example, microscopic currents that are associated with electrons in an atomic orbit. Therefore, to generate an artificial electro-magnetic field, these teachings will accommodate producing a current, to produce a resultant artificial magnetic field, and thus unite electricity and magnetism to establish an artificial electro-magnetic field. In a typical application setting, these teachings contemplate establishing a symmetrical relationship between electricity and magnetism.

A magnetic field can thus be created by causing current to flow in electrically conductive material (via a macroscopic process for magnetic field generation). A magnetic field can also be created, however, by manipulating the atomic orbits of electrons (via a microscopic process for magnetic field generation).

An artificial electro-magnetic force can result from the combination of electric and magnetic forces. Those skilled in these arts can thus produce electric current, that produces magnetization, and then combine such production from corresponding apparatus, or apparatuses, into artificial electro-magnetization.

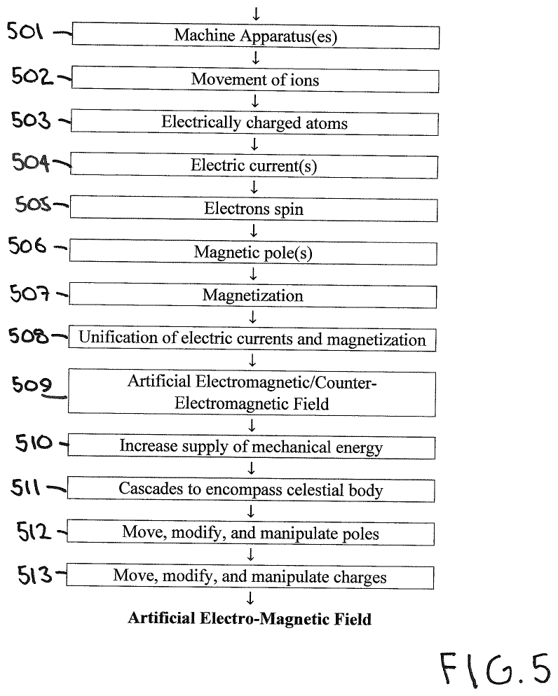

Referring to FIG. 5, these teachings will accommodate, by way of example, employing one or more apparatuses (at 501) to induce the movement of ions (at 502) to thereby establish electrically-charged atoms (at 503). The latter can then establish corresponding electric currents (at 504), which can cause electrons to spin (at 505) and thereby establish magnetic poles (at 506) to create resultant magnetization (at 507). Such an approach represents one way to achieve the unification of electric currents and magnetization (at 508) to form an artificial electro-magnetic field (at 509). The latter, in turn, can lead to an increased supply of mechanical energy (at 510) which can cascade (at 511) to encompass the aforementioned celestial body (such as Earth). As part of controlling the overall process, these teachings will accommodate moving, modifying, and/or manipulating the aforementioned poles (at 512) and/or electric charges (513), all in service of generating the aforementioned artificial electro-magnetic field.

The conductive material can possess atoms having even numbers of orbiting electrons, half of which circulate in a first direction and a remaining half that circulate in the opposite direction. Their effects would not cancel and there could be unpaired electrons that would cause the spins of the adjacent atoms and molecules to align.

Charges in motion can thus create an artificial electro-magnetic field when electric currents flow. Charged particles can be induced to flow in ordered ways from electrically conducting elements to establish an artificial electro-magnetic field. With due consideration for Maxwell's equations, these teachings, therefore, enable unification of electricity and magnetism to establish one or more artificial electro-magnetic fields when electric charges engage in an appropriate movement.

The resulting artificial electro-magnetic field can possess force with the relevant magnetic charge. An electric field may also constitute an electric force on units with positive charge, such as, for example, a proton. The teachings may provide for selectively increasing or decreasing the electric force interacting between two or more electric charges, and adjust the proportions of the products of such charges, which can be according to the distance between them. There can thus be an artificial magnetic dipole field tied to the spin of electrons. The apparatus may, therefore, induce electrons to rotate or spin. These teachings will accommodate a process that induces electrons to spin and thereby result in the emergence of a dipole artificial magnetic field (or any kind of artificial magnetic field).

Electric current that results from the process may have a flow of positive charges. The apparatus may induce the flow of electrons in any direction that may result in an equivalent, or larger, or smaller flow of positive charges in an opposite direction. These teachings may enable the apparatus, or a combination of apparatuses, to manipulate electric currents and manipulate the corresponding production of an artificial magnetic field.

The resultant artificial electro-magnetic field may create negative and positive electric charges that may have attraction/repulsion properties. For example, by one approach, the resulting artificial magnetism may have two ends, a plus end and a minus end. The two ends repel each other when facing their counterpart with the same sign. Conversely, the two ends are attracted when they face each other with the opposite sign. In one alignment, the ends of the magnetism attract each other. In the opposite alignment, they repel each other.

The resulting artificial magnetism can be dipolar with two poles, a plus pole and a minus pole. The artificial electro-magnetic field may thus arrange two charges with opposite signs to constitute an artificial electric dipole. By another approach, the artificial electro-magnetic field may arrange more than two charges with opposing signs to constitute an artificial electric non-dipole. The artificial electro-magnetic field may thus create dipole moments, or non-dipole moments, with the products of the variety of charge sizes and separation distances. The patterns of the artificial electric fields that result can be dipole-like or non-dipole-like.

The apparatus, or a combination of multiple apparatuses, may induce atomic moments on atoms. The apparatus may selectively adjust the strengths of adjacent atomic magnets. The apparatus may selectively adjust the electrical charges of atoms throughout the artificial electro-magnetic field such that the relevant ions have, more or less, electrons that would be so related.

At block 102, this process 100 provides an electrical conductor. By one approach, this electrical conductor is located on a space-borne body other than the space-borne body at which the aforementioned artificial electro-magnetic field is established. For example, the artificial electro-magnetic field may be established on a satellite that orbits the Earth upon which the aforementioned conductor is located (either on or below the Earth's surface).

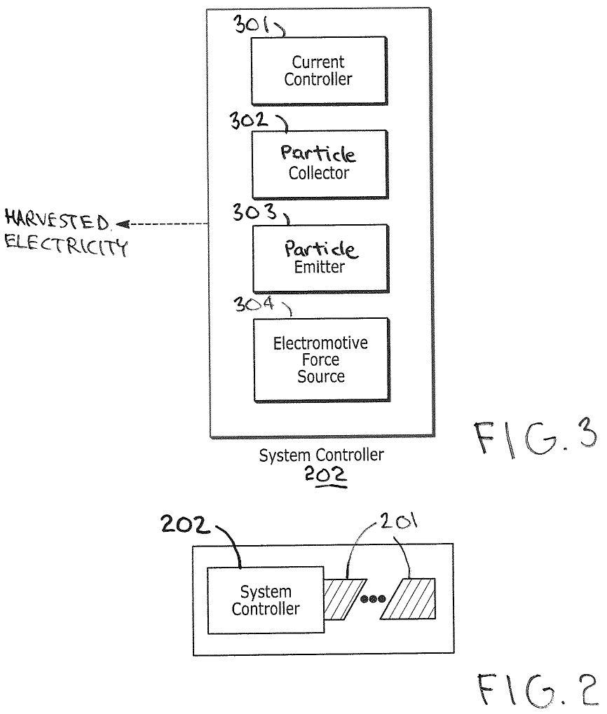

Referring momentarily to FIG. 2, part or all of the electrical conductor 201 may be shaped, for example, like a coil. Any of a variety of electrically conductive materials can be used to form the electrical conductor including aluminum, copper, and silver, alone or in combination with other materials. The size and weight of the electrical conductor 201 can vary with the needs of a particular application setting. By one approach, and as merely one illustrative example, the electrical conductor 201 may comprise at least one thousand tons of contiguous electrically-conductive material.

Depending on the application setting, the electrical conductor 201 can be operably coupled to a control circuit (styled here as a so-called system controller 202). With momentary reference to FIG. 3, this system controller 202 may include, for example, a current controller 301, a particle collector 302 (such as, but not limited to, an ion collector or an electron collector), a particle emitter 303 (such as, but not limited to, an ion emitter or an electron emitter), and/or an electromotive force source 304.

Referring again to FIG. 1, block 103 provides for harvesting electricity from the electrical conductor, which electricity is generated by relative movement between the artificial electro-magnetic field and the electrical conductor, which relative movement occurs via movement of at least one celestial body, to produce harvested electricity.

As one example, when the approach comprises an Earth-based electrical conductor and an artificial electro-magnetic field that emanates from an artificial satellite orbiting the Earth at a speed of about 28,000 kilometers per hour (or more), that relative movement between the electrical conductor and the artificial electro-magnetic field is that speed of orbiting the Earth.

As another example, when the movement between the electrical conductor and the artificial electro-magnetic field is represented by the speed of the Earth's rotation around the sun, that relative movement is a speed near or exceeding 100,000 kilometers per hour.

Per the Lorentz force law, a particle carrying a one coulomb (C) charge, and moving perpendicularly at one meter a second (m/s) through a magnetic field with one tesla (T) magnetic flux density, experiences a one Newton (N) magnitude force. Thus:

$$T = \frac{N \cdot s}{C \cdot m}$$

To carry overflight power conversion further, a 1 tesla magnetic flux density is equal to a 1 weber (Wb) magnetic flux through a one square meter surface. Therefore:

$$T = \frac{Wb}{{m}^{2}}$$

A tesla can also be expressed in SI base units only where:

$$T = \frac{kg}{A \cdot {s}^{2}}$$

Coulombs can be derived from amperes (A) where C=A·s, such that:

$$T = \frac{N}{A \cdot m}$$

Newtons are related to joules (J) such that: J=N·m, where:

$$T = \frac{J}{A \cdot {m}^{2}}$$

And volts (V) can be derived from the Weber such that: Wb=V·s, where:

$$T = \frac{V \cdot s}{{m}^{2}}$$

To carry an overflight power conversion process to a conclusion, consider joules (J) and electric power in watts (W), where the watt is defined as a unit of power in use for quantifying the rate at which energy is transferred. One joule per second is exactly equal to one watt. Therefore:

$${E}_{( J )} = {P}_{( W )} \times {t}_{( s )}$$

where E represents energy in joules, P represents power in watts, and t represents time in seconds. Therefore, a watt of power sustained over an hour is equal to 3600 joules. Thus, to obtain one terawatt hour (TWh) of power (3.6×10¹⁵ J) at a local power plant, consider that a satellite capable of projecting an artificial electro-magnetic field towards a planet flying overhead with an orbital radius of 200 kilometers can move at 30,000 kilometers per hour. C=A·s and J=N·m such that J=N·m, such that 3,600,000,000,000,000=N·30,000,000. When there is to be a 0.1 T Field applied, then:

$$\frac{N}{A \cdot m} = T$$

where here:

$$\frac{120 , 000 , 000}{A \cdot 30 , 000 \text{,0} 00} = 0.1$$

such that:

$$\frac{kg}{A \cdot {s}^{2}} = T$$

where here:

$$\frac{kg}{40 \cdot 12 , 960 , 000} = 0.1$$

Therefore, a 51,840,000 kilogram (kg) system—basically 50 kilotons—with a 0.1 Tesla Field, will suffice to obtain 1 TW of resultant power.

For many applications, 250 TW with a 50 kiloton system may prove a more beneficial approach. Thus, if J=N·m, then 900,000,000,000,000,000=N·30,000,000 such that:

$$\frac{N}{A \cdot m} = T$$

where here:

$$\frac{30 , 000 , 000 , 000}{A \cdot 30 , 000 , 000} = 0.1$$

The Amperes will increase in this case by about two and a half orders of magnitude to 10⁴ A, consistent with the increase in power, if the Field flux is 0.1 T.

When

$$\frac{N}{A \cdot m} = \frac{kg}{A \cdot {s}^{2}} = 0.1$$

it would appear that the land-based component of the system must be roughly 1.296×10¹⁰ kg as well, also an increase of several orders of magnitude to the size, or mass, of the system. And yet it is desirable for the size, or mass, of the system to remain the same. Therefore, if J=N·m and C=A·s, and here the charge can be 3.6×10⁷ C as the Artificial Magnetic Field moves perpendicularly at around 8,333 m/s with a 0.1 T magnetic flux density through the 50 kiloton conductor, these teachings mean that a reinforced land-based system component should experience a 3×10¹⁰ N magnitude force when:

$$T = \frac{N \cdot s}{C \cdot m}$$

such that:

$$0.1 = \frac{N \cdot 3600}{36 , 000 , 000 \cdot 30 , 000 , 000}$$

such that J=30,000,000,000·30,000,000 (or 250 TW).

When A increases, thus increasing C, by an order of magnitude to a situation where an overhead satellite has around a 1 megawatt (MW) behind field. It can then be seen that J=300,000,000,000·30,000,000 (or 2.5 petawatts (PW)). Accordingly, in such a case, when 50 kiloton land-based components are added to the system, and without any additions to the space-based components of the system, roughly one ton of antimatter can be had (presuming typical current energy expenditures to achieve such a result).

The electricity harvested from the foregoing approaches can be applied in any of a wide variety of ways. By one approach, part or all of that harvested electricity can serve to provide electric power to at least one power distribution grid or, in a more dedicated approach, can provide power, at least in part, to at least one data processor and/or at least one data storage system. With regard to a conventional electrical grid, such a system is generally considered to be an interconnected network that delivers electricity to consumers from the producers of electricity. Electrical grids in various parts of Earth differ in size. In certain cases, they cover whole continents, while in other cases they may cover (only) whole countries. A conventional electric grid generally consists of: power stations, which are often located near the energy sources and away from population centers; electrical substations that step voltage up and down; electric power transmission equipment that carries power over long distances; and electric power distribution systems that send power to individual customers-voltage is usually stepped down again in the final distribution component to required service voltages.

Most electrical grids have distribution areas that operate with alternating current (AC) frequencies in three phases such that voltage swings can usually occur at nearly or almost the same time, meaning they are nearly always synchronous. Such allows for the transmission of AC power to extend throughout the area, and connects large numbers of consumers with electricity generators, which potentially enables increased efficiency in electricity markets as well as redundant generation. Thus, combined transmission and distribution of electricity in a network has been part of electricity delivery.

Electrical grids have been prone to malicious intrusions and attacks via cyberspace but also with kinetic means. The present teachings, wherein power from the electricity generation method and apparatus can be provided in a partial or completely dedicated manner, to data processing and data storage purposes can serve to enable cyber security for electric grids.

A power grid can also comprise an electric power transmission system in most application settings. Electric power transmission typically involves moving the bulk of electrical energy from a site that generates energy through a web of lines that are interconnected to an electrical substation. The electrical substation is then connected to the power distribution system which sends the load to the end consumer. In the past, such networked systems consisting of these connections were distinct from local wiring in-between the high-voltage substations and end consumers of electricity. Because power was often generated far from end consumption of a power load, the transmission system would cover great distances. Power of a given amount would have a transmission efficiency that was greater at lower amperages and higher voltages in those situations. Therefore, voltages were stepped up somewhat significantly at generating stations, and then stepped down accordingly at local substations before distribution to end consumers of such loads.

Most transmission was three-phase in these instances. When compared to single-phase, three-phase would deliver much greater amounts of power per amount of wire in use, since ground and neutral wires were shared. Furthermore, three-phase generators and motors are typically more efficient than single-phase generators and motors.

However, for these past situations with conventional conductors in use for electricity transmission, resistive losses that depended on distance were responsible in the main for losses on a conventional power grid.

High-voltage direct current can present a more efficient modality for transmitting electricity over a long distance, offering the potential for incurring only half of the losses of AC transmission. The harvested electricity offered via the present teachings can be DC. The efficiencies of transporting the harvested electricity could offset any additional costs that might be necessitated for DC/AC converter stations at the receiving end of the long distance transmission of the past.

Such transmission networks are commonly complex with redundant pathways in order to ensure the resilience over the power grid.

The physical layouts of such conventional grids were often forced by the availability of the prevailing landscapes and the corresponding geologies. More recently, conventional transmission grids were offering greater reliability with more complex mesh networks that were emerging. Redundancies that became possible allowed power to be re-routed when line failures occurred and repairs had to be done.

In a power grid electrical substations are commonly found in-between energy generators and end consumers of the generated electrical loads performing many different functions. Usually electrical substations step up voltages—transforming them from low to high—and step down voltages—transforming them from high to low. Often in a power grid the voltage is transformed several times between energy generators and final consumers of electricity.

Beyond transformers, other major components and functions of conventional substations include: circuit breakers that are employed to automatically break circuits while isolating faults in such systems; switches that control electricity flows while isolating equipment; substation busbars that typically consist of sets of three conventional conductors where one is in use for each phase of a current.

When organized accordingly, distribution becomes the final stage of power delivery. It is at this stage that electricity is carried from transmission system to end consumers. In past conventional situations, substations have connected to transmission systems where they have lowered transmission voltages, usually to a medium voltage that could range in-between 2 kilovolts (kV) and 35 kilovolts (kV). At this stage, primary distribution lines carried power with medium voltage to the distribution transformers that were usually located near the premises of end consumers. Distribution transformers would lower the voltage again to a utilization voltage. Customers that constituted demand for substantial amounts of power could be directly connected to primary distribution levels or, perhaps, sub-transmission levels.

Distribution networks for an electric grid have been divided into different types that were similar to water distribution networks. For an electric grid, there have been two main conventional types: radial or network. Accordingly, in a new combined water distribution and electric-power grid, the layout of electric and communications lines could route in a fashion that corresponds to the layout of water supply and sewer lines to achieve maximum benefits from planning and operational synergies. Routing of water and electricity delivery at the distribution level could follow the same plan and layout, such as a radial plan or other networked layout approach.

In the synchronous grids of the past, all of the generators had to be run at exactly the same frequency, and needed to stay very nearly in the same phase with each other and a corresponding conventional power grid. Both generation and consumption had to be balanced across the whole of the conventional power grid, as energy was typically consumed as it was produced. When generators were rotated, a local governor would regulate driving torque, and maintain almost constant rotation speed when loads changed. Energy was stored by rotational kinetic energy from generators in very immediate short-term situations. While speed was kept largely constant, the small deviations in the nominal system frequency were very important for regulating individual generators and were used as a way to assess grid equilibrium as a whole. When a power grid was lightly loaded, grid frequency could run above the nominal frequency. That was taken as an indicator by systems for Automatic Generation Control throughout the network that generators would need to reduce their output. Conversely, if a past conventional power grid was heavily loaded, frequency would naturally slow, and governors would adjust the relevant generators such that more power could be output. If generators had settings of identical droop speed control this would ensure that multiple generators in parallel with the same settings could share the loads in proportion to the rating they had.

In the past, there was often central control for such conventional power grids, which could change AGC system parameters over timescales from a minute to longer in efforts to further adjust the flow of regional networks and grid operating frequency. For the purposes of timekeeping, nominal frequencies would be allowed to vary for the short term, but would be adjusted to prevent clocks that were line-operated from losing or gaining significant time over a 24 hour period.

Usually, a past entire synchronous grid would run at the same frequency, while neighboring grids were not synchronized even though they would run at nominal frequencies that would be the same. Variable-frequency transformers or high-voltage direct current lines could be used to establish connections between two interconnected networks of alternating currents that would not be synchronized with each other. Such would provide interconnection benefits without the need to further synchronize over an even wider area.

A new combined water network electric-power grid is able to scale from a microgrid to a wide area synchronous or asynchronous grid. In these regards, a microgrid has been a local grid that was usually part of a regional wide-area synchronous grid, although the microgrid was able to disconnect and operate autonomously. A microgrid would do as much during times when a main grid would be affected by outages. That is known as islanding. The microgrid might run indefinitely in this manner on its own resources. In comparison to larger grids, a microgrid usually employs lower voltage distribution networks with distributed generators. Microgrids can be more resilient as well as less expensive to implement in areas that are isolated.

Wide area synchronous grids, which in North America are known as an interconnection, connect generators that deliver AC power directly to many customers using the same relative frequency. In the example of North America, four major interconnections exist—the Eastern Interconnection, the Western Interconnection, the Texas Interconnection, and the Quebec Interconnection. In the example of Europe, one massive grid connects most of the continent. Wide area synchronous grids are thus electrical grids varying from regional scales to greater territories which operate at one synchronized frequency and which are electrically tied together for normal system conditions.

The wide area synchronous grid is also known as a synchronous zone. In the past, the largest such zone by power generation was the European continent's synchronous grid, which has operated at 667 gigawatts (GW). However, the widest region served by a synchronous grid was that which serves the nation-states of what was formerly the Soviet Union.

Benefits of synchronous zones can include pooling of generation, which could result in lower costs of generation; pooling of loads, which could result in equalizing effects that are significant; the common provisioning of reserves, which could result in cheaper primary as well as secondary reserve costs of power; opening of markets, which could result in the possibility of long-term contracts in addition to short term exchanges of power; and mutual assistance if there are disturbances. In these regards, neighboring interconnections that have the same standards and frequency could be synchronized to connect directly to form larger interconnections, or they could share power without synchronization with variable-frequency transformers (VFTs), or through power transmission lines with high-voltage direct current ties, which would permit controlled energy flows while also enabling independent AC frequencies from each side to be functionally isolated. However, a disadvantage of the wide-area synchronous grids of the past could be that problems from one part of the zone would have repercussions that would cascade across the whole of the past conventional power grids.

Sophisticated modern societies thus depend on reliable baseload energy, especially global information technology markets which are prominent characteristics of the sophistication of such societies. The firm zero-emission (or near zero-emission) electricity resources of the present invention present the ability to power data centers, supercomputers, and/or supercomputing data centers according to foregoing approaches. In these regards, the metrics for energy efficiency of supercomputer systems are most commonly measured with floating-point operations per second (FLOPS) per watt.

As examples of capacity computing approaches that use computing power in the most efficient and cost-effective way to solve multiple problems that are somewhat large or a lengthy amount of many small problems, municipalities and the just-in-time inventory systems of many companies use capacity computing in the form of data centers. However, a data center can host a supercomputer as well and then the facility may become capable of both capability and capacity computing.

Supercomputing is a particular form of high-performance computing wherein it is possible to significantly reduce the overall time for obtaining solutions for complex problems by using a powerful computer—a supercomputer—to determine or calculate such solutions. By connecting computers—memory and processors—it becomes possible to create larger computers. Supercomputers are thus made up of memory and processor cores, interconnects, and I/O systems. The main difference between a supercomputer and the Internet is that in a supercomputer the connections are made via internal circuits and on the Internet the connections are made via external circuits.

Vector processors operate on large data arrays. Supercomputers are more commonly designed to support significant parallel processing. Massively parallel systems commonly possess at least tens of thousands of processors. In a truly massively parallel computer, an extremely large amount of processors work together to solve the different aspects of a single problem that is extremely large and/or complex. In contrast, a vector supercomputer system is designed to run on a single data stream as quickly as possible. In the parallel supercomputer concept, the computer feeds the separate parts of a stream of data, or data streams, to entirely different processors which then recombine the results.

Regarding quantum computing, quantum computers can be implemented as photons, ions, electrons, or atoms, and can store data as qubits—quantum bits. Qubits can act as storage elements and can also combine for implementation of a hardware processor.

Because these teachings are readily scalable, these teachings will accommodate generating considerable amounts of harvested electricity. Accordingly, these teachings will also support using (likely large amounts of) harvested electricity to create antimatter anti-particles, to produce hydrogen (for example, by electrolysis, where an electric current splits water into hydrogen and oxygen molecules), to power digital currency mining and/or blockchain transactions processing, and so forth.

Further details that comport with these teachings will now be presented. It will be understood that the specific details of these examples are intended to serve an illustrative purpose and are not intended to suggest any particular limitations with respect to these teachings.

High-energy particle accelerators produce antiprotons during a process of colliding high-energy proton beams with targets that are solid. Resulting reactions have long since produced copious numbers of a wide variety of particles through nuclear events and pair production. Small percentages of such ejecta can be confined magnetically and then focused so as to separate out antiprotons. These antiprotons can then be decelerated and placed into a confinement ring to be used according to the large number of uses that antimatter has.

Electromagnetic storage devices for antimatter are known in the art and are capable of decelerating and cooling antiprotons. Storage experiments have used Penning traps, while even more advanced devices have emerged. At the European Laboratory for Particle Physics (CERN), for example, antiprotons were routinely slowed in matter, then trapped, and electron-cooled to the relevant temperature. Particle accelerators have long been capable of delivering antiprotons in at least 100 MeV/c pulses. Such pulses are relatively less intense, but are available relatively often at a common particle accelerator. There are antiproton stacking techniques that allow for the accumulation of antiprotons deriving from successive pulses within an antimatter trap, such as in the foregoing examples. Relevant trapping techniques that have long since been known in the art are: slowing antiprotons in matter, such as from at least 6 MeV to at least 3 keV; capturing the antiprotons in a trap; electron cooling the trapped antiprotons; the stacking of antiprotons; and applying a pressure below 5×10⁻¹⁷ Torr. Those skilled in the art have believed that the most efficient way to transport antimatter to outer space would be in the form of atomic antihydrogen that would be electrically neutral and stored in magnetic bottles that would be relatively small in most application settings.

It has been believed by those skilled in the art that following production within Earth-based facilities, antiparticles require a high-vacuum environment to be suspended in magnetic, electric, and/or radio frequency fields so as to avoid losses normally due to annihilation with container walls and air nuclei. Magnetostatic trapping techniques for anti-atoms or neutral atoms are known in the art to be accomplished, for example, by creating magnetic field magnitude with a local minimum in free space. The present teachings can be configured to readily provide sufficient usable energy to enable both creating and containing potentially copious amounts of antimatter.

Methods with which to produce hydrogen without using fossil fuels have involved water splitting processes—the splitting of water molecules into their two constituent parts: oxygen and hydrogen. Electrolysis has been the most well-developed method in these respects. Electrolysis utilizes electricity with which to split water into oxygen and hydrogen. Water electrolysis is capable of operating at temperatures between 50-80° C., while in comparison steam reforming required temperatures that were in between 700-1100° C. The major difference between these two methods is that the primary energy used to produce hydrogen is electricity for electrolysis of water and for natural gas it is the steam reforming of methane. The basics of water electrolysis have long since been established. For many decades hydrogen has been produced with electrolysis by passing the required electricity through at least two electrodes in water. Water molecules are thus split and oxygen is produced at the anode while hydrogen is produced at the cathode. Alkaline electrolyzers and proton exchange membrane electrolyzers (PEM) are standard water electrolysis technologies long since known to those skilled in the art. Again, the present teachings can serve to power the generation of hydrogen in potentially large quantities (and with a minimum of environmental impact) which hydrogen can then be used as clean energy source for a wide variety of applications.

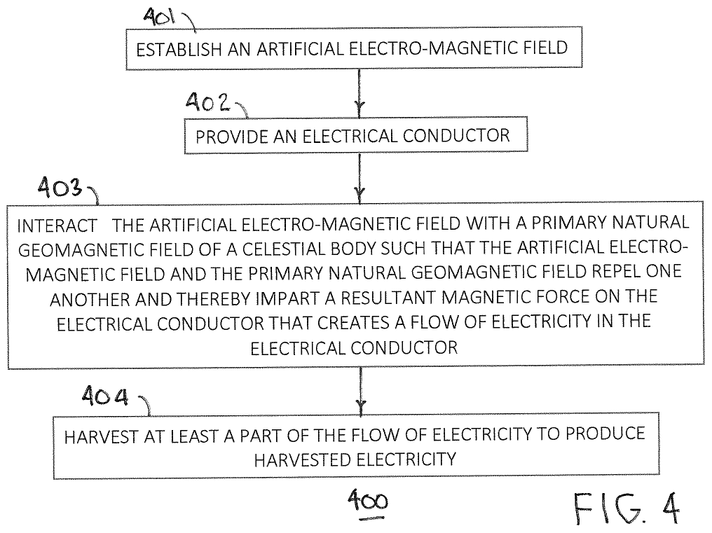

Referring to FIG. 4, by one approach a corresponding process 400 provides, at block 401, for establishing an artificial electro-magnetic field and then, at block 402, for providing an electrical conductor. At block 403 this process 400 then provides for interacting the artificial electro-magnetic field with a primary natural geomagnetic field of a celestial body (such as Earth's primary natural geomagnetic field) such that the artificial electro-magnetic field and the primary natural geomagnetic field repel one another and thereby impart a resultant magnetic force on the electrical conductor that creates a flow of electricity in the electrical conductor. At block 404, one can then harvest at least a part of the resultant flow of electricity to produce harvested electricity.

By one illustrative example, these teachings will accommodate providing a space-based component that is disposed in motion with respect to a celestial body (such as a satellite that orbits the Earth), the space-based component comprising, at least in part, an artificial electro-magnetic field generator that generates an artificial electro-magnetic field. At least one electrical conductor can be disposed on that celestial body, the at least one electrical conductor comprising a harvested electricity output configured to output electricity that is generated by relative movement between the artificial electro-magnetic field and the at least one electrical conductor, which relative movement occurs via movement of the at least one celestial body. A 50 thousand ton conductor with a 0.1 Tesla artificial electro-magnetic field applied from a satellite in around the Earth is capable of 1 terawatt when at least 400 A is used to generate the artificial electro-magnetic field. The use of 400 Amps is common for the electricity requirements of many average homes in the United States by way of comparison.

As another illustrative example, these teachings will accommodate rotating an artificial electro-magnetic field generated by an interior element through an exterior element of electrically-conductive material. This can comprise, for example, providing an apparatus that includes an electrically-conductive material (shaped, for example, as a hollow coil) and an artificial electro-magnetic field generator that is disposed at least substantially within the electrically-conductive material, the artificial electro-magnetic field generator being configured to generate an artificial electro-magnetic field that rotates through the electrically-conductive material to produce electricity. This apparatus can also include a harvested electricity output operably coupled to the electrically-conductive material and which is configured to output electricity generated as a function of the artificial electro-magnetic field.

As yet another example, the artificial electro-magnetic field generator can be situated next to, but not within, the electrically-conductive material. The artificial electro-magnetic field generator can be configured to spin the resultant artificial electro-magnetic field through the at least one element of electrically-conductive material to produce harvested electricity.

And as yet another example, these teachings will accommodate having an Earth-based artificial electro-magnetic field generator be configured to rotate the resultant artificial electro-magnetic field across a system of multiple electrically-conductive elements globally, regionally, or locally to produce harvested electricity.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A method comprising:
establishing an artificial electro-magnetic field;
providing an electrical conductor;
harvesting electricity from the electrical conductor that is generated by relative movement between the artificial electro-magnetic field and the electrical conductor, which relative movement occurs via movement of at least one celestial body, to produce harvested electricity.

2. The method of claim 1 wherein the at least one celestial body comprises one of:
a natural space-borne body;
an artificial space-borne body.

3. The method of claim 1 wherein the at least one celestial body comprises both a natural space-borne body and an artificial space-borne body.

4. The method of claim 3 wherein the artificial space-borne body orbits the natural space-borne body.

5. The method of claim 1 wherein the celestial body comprises Earth.

6. The method of claim 1 wherein establishing the artificial electro-magnetic field comprises establishing the artificial electro-magnetic field from a body other than a space-borne body that includes the electrical conductor.

7. The method of claim 1 wherein:
establishing the artificial electro-magnetic field comprises establishing the artificial electro-magnetic field on a given one of the at least one celestial body; and
providing the electrical conductor comprises providing the electrical conductor on the given one of the at least one celestial body.

8. The method of claim 1 wherein the relative movement is at a speed of at least 28,000 kilometers per hour.

9. The method of claim 1 wherein the relative movement is at a speed of at least 100,000 kilometers per hour.

10. The method of claim 1 further comprising:
using at least part of the harvested electricity to create antimatter anti-particles.

11. The method of claim 1 further comprising:
using at least part of the harvested electricity to produce hydrogen.

12. The method of claim 1 further comprising:
using at least part of the harvested electricity to power:
at least one data processor;
at least one data storage system.

13. The method of claim 1 further comprising:
using at least part of the harvested electricity to provide electric power to at least one power distribution grid.

14. A method comprising:
establishing an artificial electro-magnetic field;
providing an electrical conductor;
interacting the artificial electro-magnetic field with a primary natural geomagnetic field of a celestial body such that the artificial electro-magnetic field and the primary natural geomagnetic field repel one another and thereby impart a resultant magnetic force on the electrical conductor that creates a flow of electricity in the electrical conductor;
harvesting at least a part of the flow of electricity to produce harvested electricity.

15. An apparatus comprising:
a space-based component that is disposed in motion with respect to a celestial body, the space-based component comprising, at least in part, an artificial electro-magnetic field generator that generates an artificial electro-magnetic field;
at least one electrical conductor disposed on the celestial body, the at least one electrical conductor comprising a harvested electricity output configured to output electricity that is generated by relative movement between the artificial electro-magnetic field and the at least one electrical conductor, which relative movement occurs via movement of the at least one celestial body.

16. The apparatus of claim 15 wherein the space-based component orbits the celestial body.

17. The apparatus of claim 15 wherein the relative movement is at a speed of at least 28,000 kilometers per hour.

18. The apparatus of claim 15 wherein the electrical conductor comprises at least one thousand tons of electrically-conductive material.

19. The apparatus of claim 18 wherein the electrical conductor serves solely to generate electricity via relative movement between itself and the artificial electro-magnetic field and to output that electricity as harvested electricity.

20. The apparatus of claim 19 wherein at least part of the electrical conductor is shaped as a coil.

21. An apparatus comprising:
an electrically-conductive material;
an artificial electro-magnetic field generator disposed at least substantially within the electrically-conductive material, the artificial electro-magnetic field generator being configured to generate an artificial electro-magnetic field that rotates through the electrically-conductive material to produce electricity;
a harvested electricity output operably coupled to the electrically-conductive material and configured to output electricity generated as a function of the artificial electro-magnetic field.

22. A method comprising:
rotating an artificial electro-magnetic field generated by an interior element through an exterior element of electrically-conductive material to produce harvested electricity.
